(19) United States
(12) Patent Application Publication
(10) Pub. No.: US 2024/0391537 A1
(43) Pub. Date: Nov. 28, 2024

(54) TAILGATE SUBASSEMBLY PRESETTING METHOD AND TAILGATE ASSEMBLY HAVING PRESET SUBASSEMBLIES

(71) Applicant: Ford Global Technologies, LLC, Dearborn, MI (US)

(72) Inventors: Joseph Prior, Detroit, MI (US); Joshua Robert Hemphill, White Lake, MI (US); Raul Ezequiel Alvarez Ruiz, Estado de Mexico (MX); Michael Shawn Watterworth, Brighton, MI (US)

(21) Appl. No.: 18/323,445

(22) Filed: May 25, 2023

(51) Int. Cl. B62D 33/027; B62D 33/03

(52) U.S. Cl. CPC B62D 33/0273; B62D 33/0276; B62D 33/03

(57) ABSTRACT

A tailgate subassembly alignment method includes positioning at least one panel support bracket of a frame subassembly relative to a connection member of the frame subassembly, and securing the at least one panel support bracket to the connection member when the at least one panel support bracket is in a preset position. After securing the at least one panel support bracket, the method includes securing a tailgate panel assembly to the at least one panel support bracket.

### TECHNICAL FIELD

This disclosure relates generally to a tailgate and, more particularly, to presetting a tailgate having a door subassembly.

### BACKGROUND

Many motor vehicles include cargo spaces for transporting various types of cargo. A pickup truck, for example, includes a cargo bed that establishes the cargo space of the truck. A tailgate typically encloses one end of the cargo bed. The tailgate is movable between closed and open positions.

### SUMMARY

In some aspects, the techniques described herein relate to a tailgate subassembly alignment method, including: positioning at least one panel support bracket of a frame subassembly relative to a connection member of the frame subassembly; securing the at least one panel support bracket to the connection member when the at least one panel support bracket is in a preset position; and after securing the at least one panel support bracket, securing a tailgate panel assembly to the at least one panel support bracket.

In some aspects, the techniques described herein relate to a tailgate subassembly alignment method, wherein the tailgate panel assembly is a driver side panel assembly and the at least one panel support bracket is at least one driver side panel support bracket, wherein the frame subassembly includes a cargo bed access opening between the driver side panel assembly and a passenger side panel assembly, wherein a door subassembly is pivotably secured to the frame subassembly, the door subassembly pivotable back-and-forth between a door open position and a door closed position, the door subassembly closing the cargo bed access opening when the door subassembly is in the door closed position, the door subassembly and the frame subassembly together providing a tailgate assembly.

In some aspects, the techniques described herein relate to a tailgate subassembly alignment method, further including presetting the door subassembly of the tailgate assembly relative to the frame subassembly of the tailgate assembly.

In some aspects, the techniques described herein relate to a tailgate subassembly alignment method, wherein a hinge side of the door subassembly is pivotably connected to one of the driver side panel assembly or the passenger side panel assembly, wherein a latch side of the door subassembly is latched to the other of the driver side panel assembly or the passenger side panel assembly.

In some aspects, the techniques described herein relate to a tailgate subassembly alignment method, wherein the presetting of the door subassembly includes presetting the door subassembly such that the latch side is shifted vertically upwards relative to the hinge side within the cargo bed access opening.

In some aspects, the techniques described herein relate to a tailgate subassembly alignment method, wherein, when the driver side panel assembly is secured to the at least one driver side panel support bracket in the preset position, the driver side panel assembly is tilted outboard such that the cargo bed access opening is wider at a vertical top of the cargo bed access opening than at a vertical bottom of the cargo bed access opening.

In some aspects, the techniques described herein relate to a tailgate subassembly alignment method, further including: positioning at least one passenger side panel support bracket relative to the connection member; securing the at least one passenger side panel support bracket to the at least one passenger side panel support bracket in a preset position; and after securing the at least one passenger side panel support bracket, securing the passenger side panel assembly to the at least one passenger side panel support bracket.

In some aspects, the techniques described herein relate to a tailgate subassembly alignment method, wherein the connection member extends continuously and uninterruptedly from a driver side of the cargo bed access opening, along a bottom of the cargo bed access opening, and to a passenger side of the cargo bed access opening.

In some aspects, the techniques described herein relate to a tailgate subassembly alignment method, wherein the frame subassembly and the door subassembly are configured pivot together relative to a vehicle structure about a horizontally extending axis, wherein the door subassembly is configured to pivot relative to the frame subassembly about a vertically extending axis.

In some aspects, the techniques described herein relate to a tailgate subassembly alignment method, further including securing the door subassembly to the frame subassembly after presetting the door subassembly.

In some aspects, the techniques described herein relate to a tailgate subassembly alignment method, wherein the tailgate assembly is pivotable relative to a vehicle structure about a horizontal axis back-and-forth between a tailgate closed position and a tailgate open position.

In some aspects, the techniques described herein relate to a tailgate subassembly alignment method, wherein the panel support bracket in the preset position offsets the frame subassembly from a design position for the frame subassembly.

In some aspects, the techniques described herein relate to a tailgate subassembly alignment method, wherein the connection member has a u-shaped cross section, the at least one panel support bracket including a panel support bracket that slips relative to the connection member.

In some aspects, the techniques described herein relate to a tailgate subassembly alignment method, wherein securing the at least one panel support bracket to the connection member includes welding the at least one panel support bracket to the connection member.

In some aspects, the techniques described herein relate to a tailgate subassembly alignment method, further including securing the frame subassembly to a vehicle cargo bed after presetting the frame subassembly.

In some aspects, the techniques described herein relate to a tailgate assembly, including: a frame subassembly having a cargo bed access opening between a driver side panel assembly and a passenger side panel assembly, the frame subassembly including a plurality of panel support brackets secured to a connection member, the plurality of panel support brackets secured to the connection member to preset the frame subassembly.

In some aspects, the techniques described herein relate to a tailgate assembly, further including a door subassembly that is pivotably coupled to the frame subassembly, the door subassembly pivotable relative to the frame subassembly back-and-forth between a door open position and a door closed position, the door subassembly closing the cargo bed access opening when the door subassembly is in the door closed position, the door subassembly offset from a preset door subassembly position, the door subassembly secured to a structure of a vehicle in the preset door subassembly position.

In some aspects, the techniques described herein relate to a tailgate assembly, wherein the frame subassembly and the door subassembly pivot together about a horizontally extending axis, wherein the door subassembly pivots relative to the frame subassembly about a vertically extending axis.

In some aspects, the techniques described herein relate to a tailgate assembly, wherein the driver side panel assembly is on a driver side of the cargo bed access opening in the tailgate assembly, and the passenger side panel assembly is on a passenger side of the cargo bed access opening.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 is a rear perspective view of a motor vehicle equipped with a cargo space and a tailgate assembly positioned in a tailgate closed position relative to the cargo space.

FIG. 2 illustrates the tailgate assembly of FIG. 1 in a tailgate open position.

FIG. 3 illustrates a door subassembly of the tailgate assembly of FIG. 1 in a door open position.

FIG. 4 is a rear and top view of the tailgate assembly and the door subassembly of FIG. 3.

FIG. 5 illustrates a connection assembly from the tailgate assembly of FIG. 1. FIG. 6 illustrates an expanded view of the connection assembly of FIG. 5.

FIG. 7 illustrates inner panels of driver and passenger side panel assemblies secured to the connection assembly of FIG. 5.

FIG. 8 illustrates outer panels of driver and passenger side panel assemblies secured to respective inner panels and the connection member of FIG. 7.

FIG. 9 illustrates a perspective view of panel support brackets of the connection assembly during assembly to the connection member of the connection assembly.

FIG. 10 illustrates a section view taken at line 10-10 in FIG. 8.

FIG. 11 illustrates a section view taken at line 11-11 in FIG. 8.

FIGS. 12A-12D illustrate the tailgate assembly at various stages of assembly.

### DETAILED DESCRIPTION

This disclosure details exemplary methods of presetting tailgate assemblies that include door subassemblies. Generally, presetting is the installing of a part in a position misaligned or offset from a desired installed position for that part. After completing installation, the weight of the part can cause the part to sag or otherwise move from the preset position into a desired design position for the part.

For example, a vehicle may be designed to have a three to five millimeter gap between a first component that is secured to a vehicle frame and a second component that is secured to the vehicle frame. During assembly, the first component is secured to the vehicle frame. Next, the second component is supported by installation tooling and secured to the vehicle frame with a six to eight millimeter gap to the first component, which “presets” the second component. After the second component is secured and installation tooling is no longer supporting the second component, the weight of the second component causes the second component to sag a bit toward the first component. The sagging reduces the gap between the first component and the second component to the desired three to five millimeter gap.

The preset ensures a desired fit and finish, and that functional requirements are met. Functional requirements can include aligned sealing interfaces, for example.

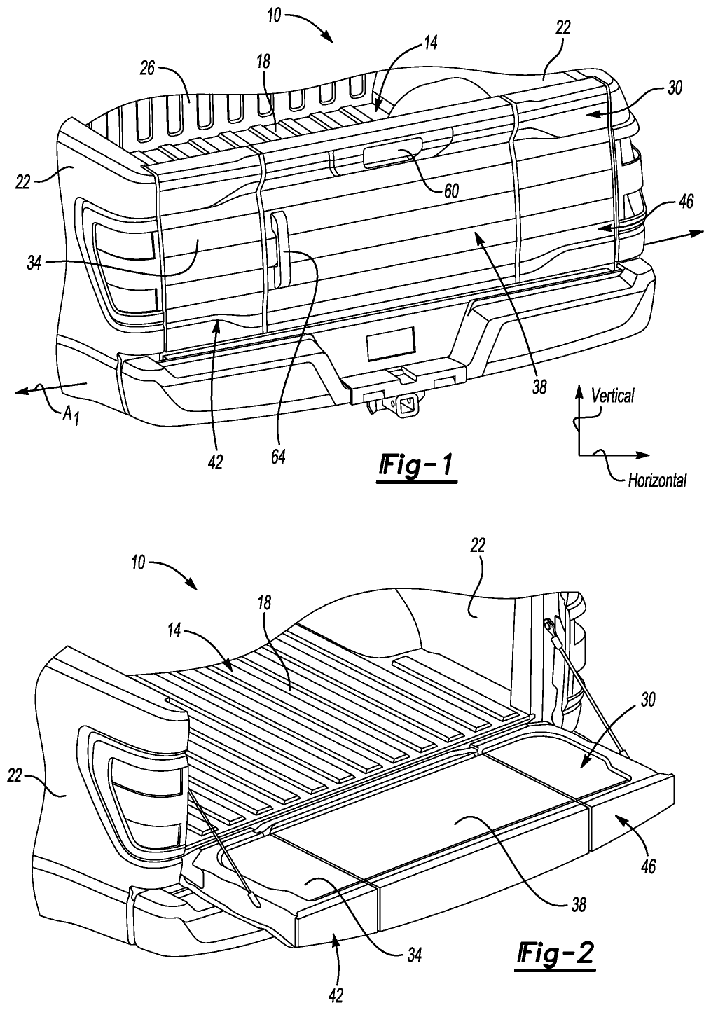

FIGS. 1-4 illustrate selected portions of a motor vehicle 10 that includes a cargo space for storing and/or hauling cargo. In the illustrated embodiment, the vehicle 10 is a pickup truck and the cargo space is established by a cargo bed 14 of the pickup truck. While a pickup truck with a cargo bed is specifically depicted and referenced herein, other vehicles having other types of cargo spaces could also benefit from the teachings of this disclosure. The vehicle 10 could be a conventional, internal combustion engine powered vehicle, a traction battery powered electric or hybrid vehicle, an autonomous vehicle (i.e., a driverless vehicle), etc.

Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component.

The cargo bed 14 is generally rearward of a passenger cabin (not shown) of the vehicle 10 and includes a floor 18 extending between a pair of longitudinally extending sidewalls 22, a laterally extending front wall 26, and a tailgate assembly 30. The overall size, shape, and configuration of the cargo bed 14 are not intended to limit this disclosure.

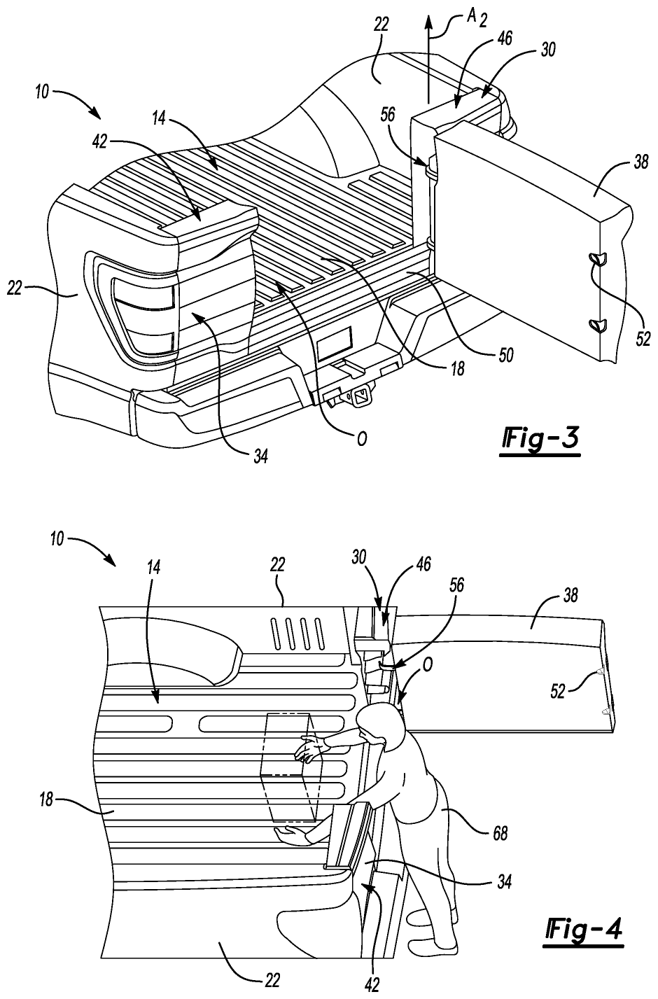

The tailgate assembly 30 can be considered a Multi-Axis Tailgate that includes, among other things, a frame subassembly 34 and a door subassembly 38. The frame subassembly 34, in the exemplary embodiment, includes a driver side panel assembly 42, a passenger side panel assembly 46, and a connection assembly 50 (see FIG. 3) that connects the driver side panel assembly 42 and the passenger side panel assembly 46.

The door subassembly 38 may sometimes be referred to as a “swing gate subassembly.” The door subassembly 38 is pivotably connected to the passenger side panel assembly 46 and latches to the driver side panel assembly 42 through a latch assembly 52 when closed. At least one hinge assembly 56 is used to pivotably connect the door subassembly 38 to the passenger side panel assembly 46. In another example, the door subassembly 38 is pivotably connected to the driver side panel assembly 42 and latches to the passenger side panel assembly 46.

The tailgate assembly 30 is pivotable about a first axis A₁ relative to the cargo bed 14 back-and-forth between a tailgate closed position shown in FIG. 1 and a tailgate open position shown in FIG. 2. The tailgate assembly 30 may be moved from the tailgate closed position to the tailgate open position in response to actuating a handle 60 of the tailgate assembly 30, for example.

The tailgate assembly 30 is vertically aligned when in the tailgate closed position and thus generally encloses an end of the cargo bed 14 that is opposite from the front wall 26, and the tailgate assembly 30 is horizontally aligned when in the tailgate open position and thus generally allows access to the cargo bed 14. Vertical and horizontal, for purposes of this disclosure, are with reference to ground in the ordinary orientation of the vehicle 10 during operation.

The door subassembly 38 of the tailgate assembly 30 is in a door closed position and is latched to the frame subassembly 34 when the frame subassembly 34 and the door subassembly 38 are pivoted between the tailgate closed position and the tailgate open position. Thus, the frame subassembly 34 and the door subassembly 38 pivot together as a unit when the tailgate assembly 30 is transitioned back and forth between the tailgate closed position and the tailgate open position.

When in the tailgate closed position, the door subassembly 38 is pivotable relative to the frame subassembly 34 about a second axis A₂ between the door closed position shown in FIG. 1 and a door open position shown in FIG. 3. In this example, the first axis A₁ is a horizontally extending axis. The second axis A₂ is transverse to the first axis A₁ and is a vertically extending axis. The door subassembly 38 may be moved between the door closed position and the door open position after actuating a second handle 64 of the tailgate assembly 30 to release the latch assembly 52, for example.

The door subassembly 38 provides a cargo bed access opening O when moved to the door open position. In an embodiment, the cargo bed access opening O extends vertically downward at least as far as the floor 18 of the cargo bed 14. A user 68 (see FIG. 4) can access the cargo bed 14 through the cargo bed access opening O when the door subassembly 38 is in the door open position. Placing the door subassembly 38 in the door open position allows the user 68 to move closer to the cargo bed 14 than, for example, when the tailgate assembly 30 is positioned in the tailgate open position of FIG. 2. The cargo bed access opening O can also provide clearance for the user 68 to enter the cargo bed 14 to either load or retrieve an item of cargo. The connection assembly 50 extends continuously and uninterruptedly from the driver side of the cargo bed access opening O, along a bottom of the cargo bed access opening, to the passenger side of the cargo bed access opening O.

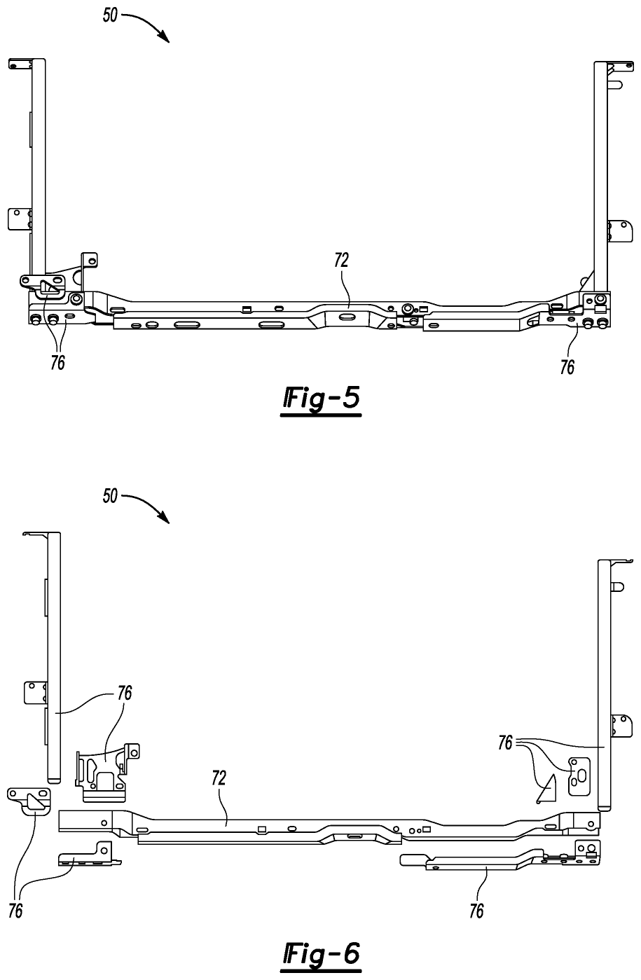

With reference now to FIGS. 5 and 6, the connection assembly 50 of the frame subassembly 34 includes a connection member 72 and a plurality of panel support brackets 76. When the connection assembly 50 is assembled, some of the panel support brackets 76 are secured to a driver side of the connection member 72, and some of the panel support brackets 76 are secured to a passenger side of the connection member 72.

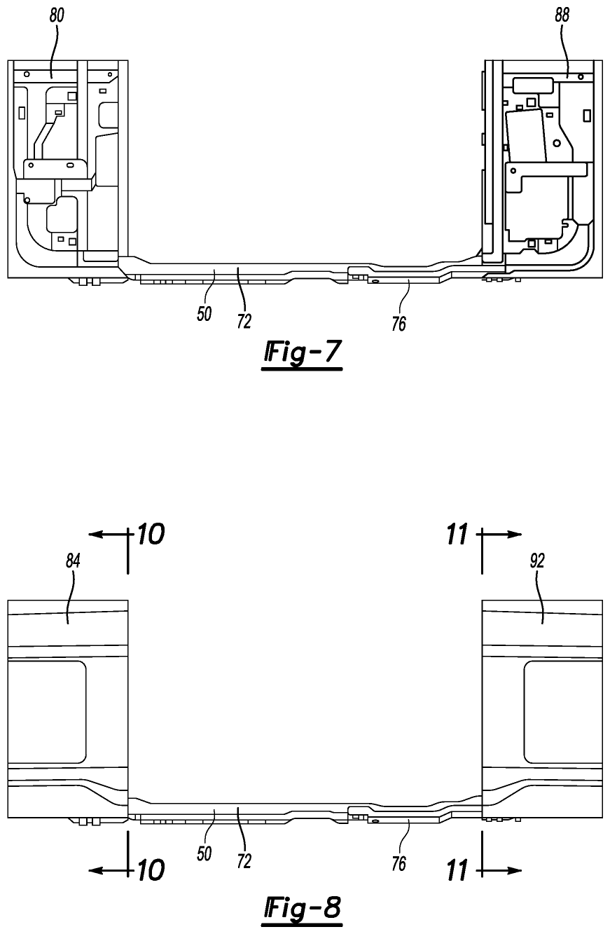

The driver side panel assembly 42 includes an inner panel 80 and an outer panel 84. After the panel support brackets 76 are secured to the driver side of the connection member 72, the inner panel 80 is secured to the panel support brackets 76 on the driver side as shown in FIG. 7. Next, the outer panel 84 is secured as shown in FIG. 8. Threaded fasteners can extend through apertures in the panel support brackets 76 to secure the driver side panel assembly 42 to the connection assembly 50.

The passenger side panel assembly 46 includes an inner panel 88 and an outer panel 92. After the panel support brackets 76 are secured to the passenger side of the connection member 72, the inner panel 88 is secured to the panel support brackets 76 on the passenger side as shown in FIG. 7. Next, the outer panel 92 is secured to the panel support brackets 76 as shown in FIG. 8. Threaded fasteners can extend through apertures in the panel support brackets 76 to secure the passenger side panel assembly 46 to the connection assembly 50.

In this example, the positioning of the driver side panel assembly 42 relative to the passenger side panel assembly 46 is controlled, at least in part, by where the panel support brackets 76 are secured to the connection member 72. In particular, where the panel support brackets 76 are secured controls how much the driver side panel assembly 42 and the passenger side panel assembly 46 are tilted away from each other.

If, for example, preseting of the frame subassembly 34 is desired such that the driver side panel assembly 42 and the passenger side panel assembly 46 are tilted two degrees outboard away from a vertical orientation, the respective panel support brackets 76 can be tilted two degrees outboard relative to the connection member 72 to a tilted or preset position. The respective panel support brackets 76 are then secured to the connection member 72 with laser welds, for example. As the support brackets 76 are in the preset position, the attachment locations used to secure the driver side panel assembly 42 are also in the preset position.

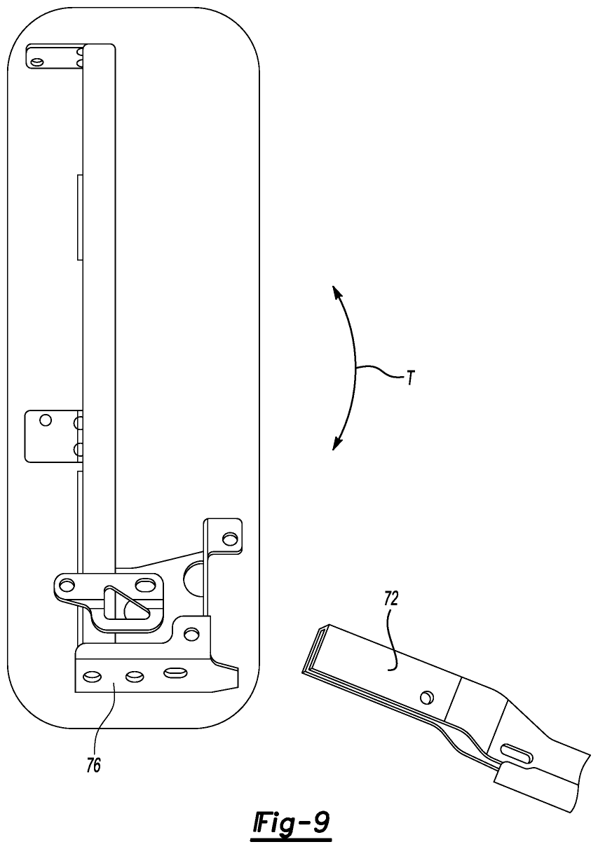

With reference now to FIG. 9, tilting the panel support brackets 76 on the driver side relative to the connection member 72 can involve holding the support brackets 76 in a first assembly fixture 82, and then rotating the first assembly fixture 82 in the direction T relative to the connection member 72 to a preset position. This coordinates the tilting of the support brackets 76 on the driver side so that the support brackets 76 do not need to be individually preset. The support brackets 76 are then secured to the connection member 72.

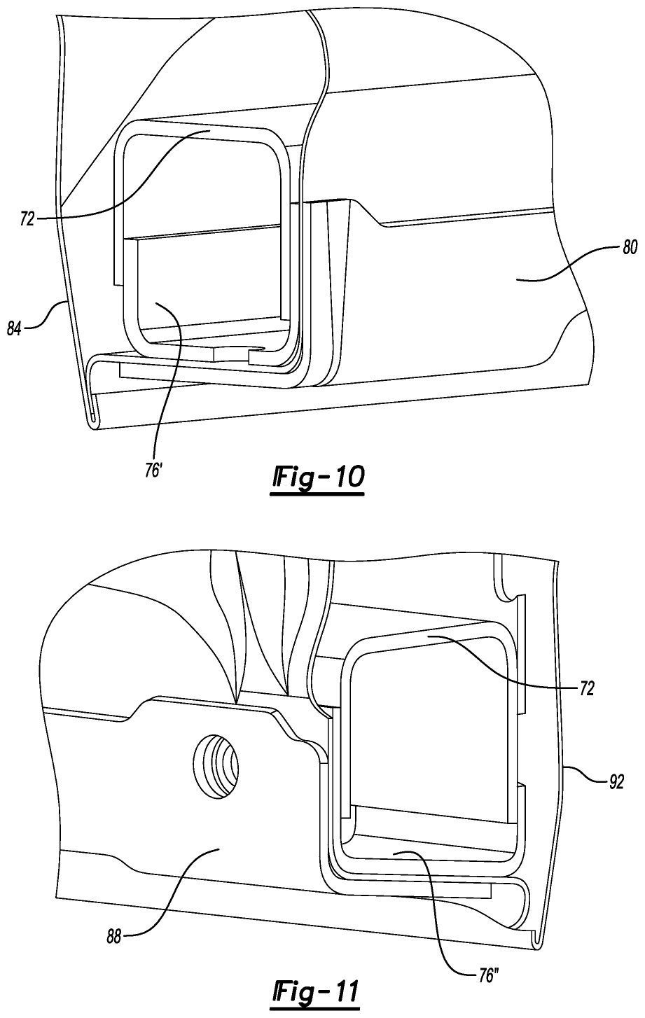

As shown in FIG. 10, the example connection member 72 has a u-shaped cross-section. One of the panel support brackets 76′ also has a u-shaped cross-section. The panel support bracket 76′ can slip relative to the connection member 72 when being tilted in direction T (FIG. 9) relative to the connection member 72.

As shown in FIG. 11, one of the panel support brackets 76″ on the passenger side can also slip relative to the connection member 72 when disposed on the preset position.

An exemplary tailgate assembly method can include presetting the frame subassembly 34 by positioning the panel support brackets 76 as described above, and also presetting the door subassembly 38. The presetting of the frame subassembly 34 is a presetting with reference to the sidewalls 22. The presetting of the door subassembly 38 is with reference to the frame subassembly 34.

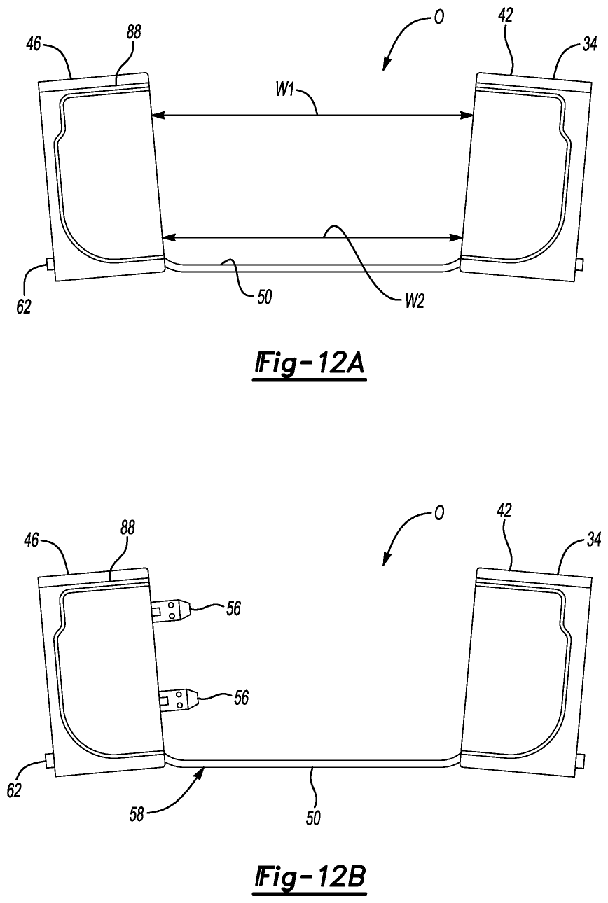

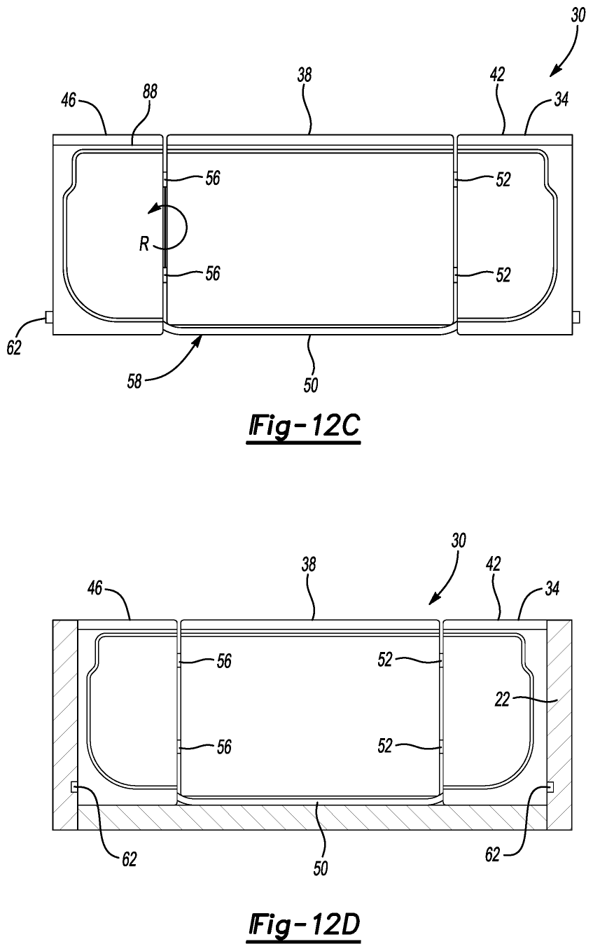

In this example, in the preset position, the driver side panel assembly 42 and the passenger side panel assembly 46 are tilted outboard away from each other such that a dimension W1 of the cargo bed access opening O is wider at a vertical top of the cargo bed access opening O than a dimension W2 of the cargo bed access opening O at a vertical bottom of the cargo bed access opening O as shown in FIG. 12A.

Since the panel support brackets 76 are secured in the preset position, the driver side panel assembly 42 and the passenger side panel assembly 46 are tilted slightly outboard from their intended design positions when secured to the panel support brackets 76. The frame subassembly 34 is in a preset frame subassembly position when the driver side panel assembly 42 and the passenger side panel assembly 46 are tilted in this way.

Next, as shown in FIGS. 12B, the hinge assemblies 56 are coupled to the passenger side panel assembly 46.

The door subassembly 38 is then installed by coupling the door subassembly 38 to the hinge assemblies 56 as shown in FIG. 12C. The weight of the door subassembly 38 can draw the driver side panel assembly 42 and the passenger side panel assembly 46 inward. The door subassembly 38 and the hinge assembly 56 can be secured such that the door subassembly 38 is tilted slightly in a direction R relative to the passenger side panel assembly 46. This positions the door subassembly 38 in a preset door subassembly position and leads to the gap between the door subassembly 38 and the passenger side panel assembly 46 widening moving downward. After the tailgate assembly 30 is installed, the weight of the door subassembly 38 cause the door subassembly 38 to stay in the design position for the door subassembly 38. This makes the gap between the door subassembly 38 and the passenger side panel assembly 46 more consistent moving downward.

The tilt of the door subassembly 38 prior to installation in the vehicle 10 is a tilt away from an intended position of the door subassembly 38 when installed within the vehicle 10. The tilting of the door subassembly 38 is a presetting of the door subassembly 38 relative to the frame subassembly 34. The tilting causes a side of the door subassembly 38 interfacing with the hinge assembly 54 to be shifted vertically downward relative to a side of the door subassembly 38 that will latch to the driver side panel assembly 42.

As shown in FIG. 12D, the tailgate assembly 30 is then positioned in an installed position on the vehicle 10 such that the tailgate assembly 30 is pivotably coupled to the vehicle 10. In the installed position, after assembly tooling supporting the tailgate assembly 30 is removed and the tailgate assembly 30 is supported through attachment pivots 62 to the sidewalls 22 of the vehicle 10. The tailgate assembly 30 can sag vertically downward after installation. The frame subassembly 34 sags from preset frame subassembly position to the design position for the frame subassembly 34, which is offset from the preset frame subassembly position. The door subassembly 38 sags from the preset door subassembly position to the design position for the door subassembly 38, which is offset from the preset frame subassembly position.

Since the frame subassembly 34 and the door subassembly 38 were each preset, the frame subassembly 34 and the door subassembly sag into their intended design position. The design position provides desired gaps and margins between the door subassembly 38 and surrounding structures and between the frame subassembly 34 and surrounding structures. The design position provides, among other things, properly aligned latches utilized to couple the door subassembly 38 to the frame subassembly 34, and maintains desired sealing interfaces

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A tailgate subassembly alignment method, comprising:
positioning at least one panel support bracket of a frame subassembly relative to a connection member of the frame subassembly;
securing the at least one panel support bracket to the connection member when the at least one panel support bracket is in a preset position; and
after securing the at least one panel support bracket, securing a tailgate panel assembly to the at least one panel support bracket.

2. The tailgate subassembly alignment method of claim 1, wherein the tailgate panel assembly is a driver side panel assembly and the at least one panel support bracket is at least one driver side panel support bracket, wherein the frame subassembly includes a cargo bed access opening between the driver side panel assembly and a passenger side panel assembly, wherein a door subassembly is pivotably secured to the frame subassembly, the door subassembly pivotable back-and-forth between a door open position and a door closed position, the door subassembly closing the cargo bed access opening when the door subassembly is in the door closed position, the door subassembly and the frame subassembly together providing a tailgate assembly.

3. The tailgate subassembly alignment method of claim 2, further comprising presetting the door subassembly of the tailgate assembly relative to the frame subassembly of the tailgate assembly.

4. The tailgate subassembly alignment method of claim 3, wherein a hinge side of the door subassembly is pivotably connected to one of the driver side panel assembly or the passenger side panel assembly, wherein a latch side of the door subassembly is latched to the other of the driver side panel assembly or the passenger side panel assembly.

5. The tailgate subassembly alignment method of claim 4, wherein the presetting of the door subassembly comprises presetting the door subassembly such that the latch side is shifted vertically upwards relative to the hinge side within the cargo bed access opening.

6. The tailgate subassembly alignment method of claim 2, wherein, when the driver side panel assembly is secured to the at least one driver side panel support bracket in the preset position, the driver side panel assembly is tilted outboard such that the cargo bed access opening is wider at a vertical top of the cargo bed access opening than at a vertical bottom of the cargo bed access opening.

7. The tailgate subassembly alignment method of claim 2, further comprising:
positioning at least one passenger side panel support bracket relative to the connection member;
securing the at least one passenger side panel support bracket to the at least one passenger side panel support bracket in a preset position; and
after securing the at least one passenger side panel support bracket, securing the passenger side panel assembly to the at least one passenger side panel support bracket.

8. The tailgate subassembly alignment method of claim 5, wherein the connection member extends continuously and uninterruptedly from a driver side of the cargo bed access opening, along a bottom of the cargo bed access opening, and to a passenger side of the cargo bed access opening.

9. The tailgate subassembly alignment method of claim 2, wherein the frame subassembly and the door subassembly are configured pivot together relative to a vehicle structure about a horizontally extending axis, wherein the door subassembly is configured to pivot relative to the frame subassembly about a vertically extending axis.

10. The tailgate subassembly alignment method of claim 2, further comprising securing the door subassembly to the frame subassembly after presetting the door subassembly.

11. The tailgate subassembly alignment method of claim 2, wherein the tailgate assembly is pivotable relative to a vehicle structure about a horizontal axis back-and-forth between a tailgate closed position and a tailgate open position.

12. The tailgate subassembly alignment method of claim 1, wherein the panel support bracket in the preset position offsets the frame subassembly from a design position for the frame subassembly.

13. The tailgate subassembly alignment method of claim 1, wherein the connection member has a u-shaped cross section, the at least one panel support bracket including a panel support bracket that slips relative to the connection member.

14. The tailgate subassembly alignment method of claim 1, wherein securing the at least one panel support bracket to the connection member comprises welding the at least one panel support bracket to the connection member.

15. The tailgate subassembly alignment method of claim 1, further comprising securing the frame subassembly to a vehicle cargo bed after presetting the frame subassembly.

16. A tailgate assembly, comprising:
a frame subassembly having a cargo bed access opening between a driver side panel assembly and a passenger side panel assembly, the frame subassembly including a plurality of panel support brackets secured to a connection member, the plurality of panel support brackets secured to the connection member to preset the frame subassembly.

17. The tailgate assembly of claim 16, further comprising a door subassembly that is pivotably coupled to the frame subassembly, the door subassembly pivotable relative to the frame subassembly back-and-forth between a door open position and a door closed position, the door subassembly closing the cargo bed access opening when the door subassembly is in the door closed position, the door subassembly offset from a preset door subassembly position, the door subassembly secured to a structure of a vehicle in the preset door subassembly position.

18. The tailgate assembly of claim 17, wherein the frame subassembly and the door subassembly pivot together about a horizontally extending axis, wherein the door subassembly pivots relative to the frame subassembly about a vertically extending axis.

19. The tailgate assembly of claim 16, wherein the driver side panel assembly is on a driver side of the cargo bed access opening in the tailgate assembly, and the passenger side panel assembly is on a passenger side of the cargo bed access opening.
